(19) United States
(12) Patent Application Publication
(10) Pub. No.: US 2022/0373968 A1
(43) Pub. Date: Nov. 24, 2022

(54) IMAGE FORMING APPARATUS

(71) Applicant: KYOCERA Document Solutions Inc., Osaka (JP)

(72) Inventor: Takehiro SATO, Osaka-shi (JP)

(73) Assignee: KYOCERA Document Solutions Inc., Osaka (JP)

(21) Appl. No.: 17/749,608

(22) Filed: May 20, 2022

(30) Foreign Application Priority Data
May 24, 2021 (JP) 2021-087029

(51) Int. Cl. G03G 21/20; G03G 15/20

(52) U.S. Cl. CPC G03G 21/206; G03G 15/2028; G03G 15/2064

(57) ABSTRACT

An image forming apparatus includes a conveyance device, a fixing device and an air blower. The conveyance device conveys a medium along a conveyance guide. The fixing device fixes a toner image on the medium thermally by passing the medium between a fixing member and a pressing member which are rotated around axes. The air blower sucks air above the conveyance guide to attract the medium to the conveyance guide, and blows the sucked air to a pair of medium non-passing regions set on both end portions of at least the fixing member and the pressing member in the axial direction.

### INCORPORATION BY REFERENCE

This application is based on and claims the benefit of priority from Japanese patent application No. 2021-087029 filed on May 24, 2021, which is incorporated by reference in its entirety.

### BACKGROUND

The present disclosure relates to an image forming apparatus.

An image forming apparatus is known, which includes an air blowing means for blowing air to a conveyed transfer material at a predetermined position when the transfer material passes through the predetermined position on a sheet conveyance path. Since the transfer material is conveyed while being pressed against one surface of the sheet conveyance path by the air blown from the air blowing means, stable sheet conveyance is allowed.

There is also known an image forming apparatus in which a sheet passing reference is set at a predetermined position at the end portion of the fixing roller of the fixing apparatus, and a cooling fan forms an airflow from the end portion opposite to the sheet passing reference end portion of the fixing roller toward the sheet passing reference end portion. This makes it possible to prevent excessive temperature rise of the fixing roller and to obtain a good fixed image.

However, in the former image forming apparatus, the posture of the transfer material may be disturbed owing to the blown air, and it cannot be said that the stable sheet conveyance is always allowed.

Further, in the latter image forming apparatus, the cooling fan for cooling the fixing roller is not used for stable sheet conveyance on the sheet conveyance path, and in order to achieve stable sheet conveyance in the image forming apparatus, it is necessary to provide an air blowing means in addition to the cooling fan.

### SUMMARY

In accordance with one aspect of the present disclosure, an image forming apparatus includes a conveyance device, a fixing device and an air blower. The conveyance device conveys a medium along a conveyance guide. The fixing device fixes a toner image on the medium thermally by passing the medium between a fixing member and a pressing member which are rotated around axes. The air blower sucks air above the conveyance guide to attract the medium to the conveyance guide, and blows the sucked air to a pair of medium non-passing regions set on both end portions of at least the fixing member and the pressing member in the axial direction.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a front view schematically showing an inside of an image forming apparatus according to one embodiment of the present disclosure.

FIG. 2 is a sectional front view showing a fixing device, a conveyance device and the others in the image forming apparatus according to the embodiment of the present disclosure.

FIG. 3 is a side view showing an intake/exhaust structure and the others in the image forming apparatus according to the embodiment of the present disclosure.

### DETAILED DESCRIPTION

Hereinafter, with reference to the attached drawings, one embodiment of the present embodiment will be described. In the following description, Fr, Rr, L, R, U and D marked in the drawings indicate the front, rear, left, right, upper and lower. Although terms indicating a direction or a position are used in the description, they are used for convenience of explanation and are not intended to limit the technical scope of the present disclosure.

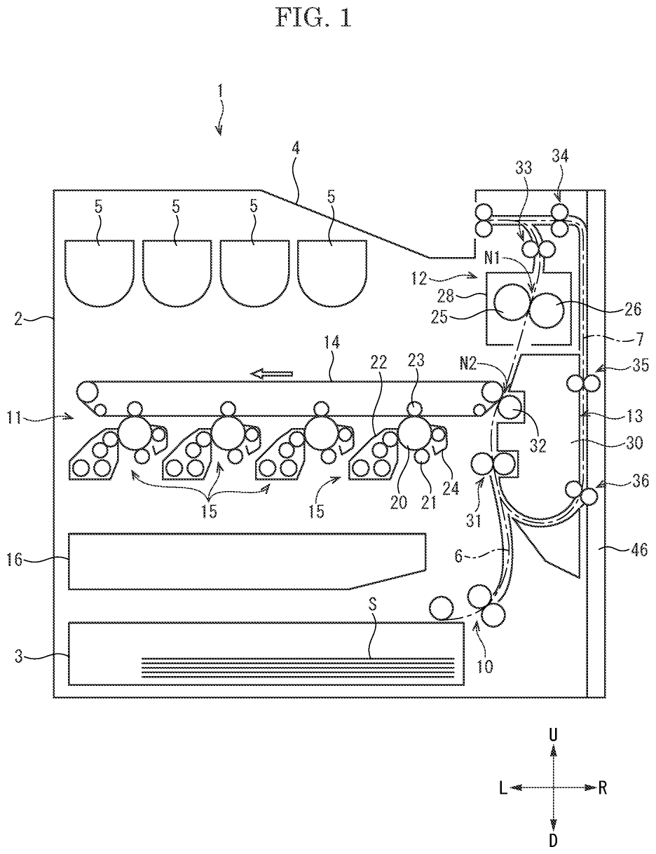

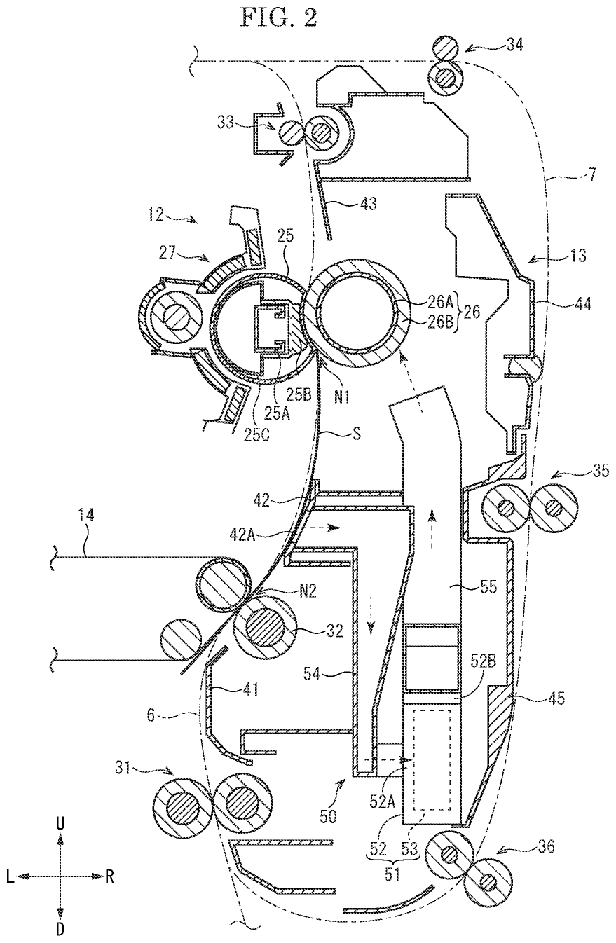

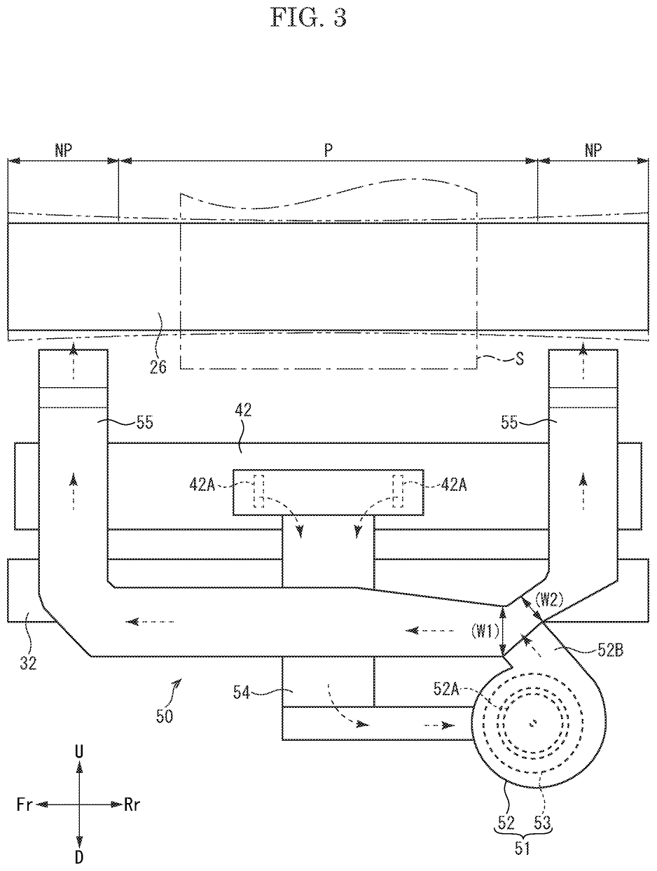

With reference to FIG. 1 to FIG. 3, an image forming apparatus 1 according to the embodiment will be described. FIG. 1 is a front view schematically showing the inside of the image forming apparatus 1. FIG. 2 is a sectional view (a front view) showing a fixing device 12, a conveyance device 13, and the others. FIG. 3 is a side view showing an intake/exhaust structure 50 and the others.

[Image Forming Apparatus] The image forming apparatus 1 is a color printer that transfers a full-color toner image formed by an electrophotographic method to form an image on a sheet S (a medium). As shown in FIG. 1, the image forming apparatus 1 includes an apparatus main body 2 constituting an approximately rectangular parallelepiped appearance. A cassette 3 in which the sheet S is stored is detachably provided in the lower portion in the apparatus main body 2, and a sheet discharge tray 4 on which the sheet S formed with an image is discharged is provided on the upper surface of the apparatus main body 2. Below the sheet discharge tray 4, four toner containers 5 containing toner (developer) of four colors (magenta, cyan, yellow and black) are detachably attached. The medium is not limited to the paper sheet S, but may be a resin sheet or the like.

In the right side portion in the apparatus main body 2, a conveyance path 6 and an inversion conveyance path 7 serving as a conveyance path for the sheet S are formed. The conveyance path 6 is formed in an approximately S-shape along the upper-and-lower direction, and is a path for conveying the sheet S from the cassette 3 to the sheet discharge tray 4. The inversion conveyance path 7 branches rightward from the downstream portion of the conveyance path 6, extends downward, and merges with the upstream portion of the conveyance path 6. The inversion conveyance path 7 is a path for turning the sheet S upside down and conveying it again to an image forming device 11 described later. In this specification, the term “upstream” and “downstream” refers to “upstream” and “downstream” in the conveyance direction of the sheet S (the medium).

Inside the apparatus main body 2, a sheet feeding device 10, the image forming device 11, the fixing device 12, and the conveyance device 13 are provided. The sheet feeding device 10 is provided at the upstream end portion of the conveyance path 6, and has a function of feeding the sheets S stored in the cassette 3 to the conveyance path 6 while separating them one by one. The fixing device 12 is provided on the downstream portion of the conveyance path 6, and the image forming device 11 is provided between the sheet feeding device 10 and the fixing device 12 on the conveyance path 6. The conveyance device 13 has the first to third conveyance guides 41 to 43 and the others which constitute a part of the conveyance path 6 and the inversion conveyance path 7, and has a function of conveying the sheet S along the first to third conveyance guides 41 to 43 and the others.

<Image Forming Device> The image forming device 11 includes an intermediate transfer belt 14, four drum units 15, and an optical scanner 16. The intermediate transfer belt 14 is provided below the toner containers 5, wound around a plurality of rollers, and travels in the direction indicated by the arrow in FIG. 1. The four drum units 15 are arranged below the intermediate transfer belt 14 side by side in the left-and-right direction, and the optical scanner 16 is provided below the drum units 15. The four drum units 15 correspond to the magenta, cyan, yellow and black toners in order from the left to the right. Since the four drum units 15 have the same structure, one drum unit 15 will be described below.

The drum unit 15 includes a photosensitive drum 20, a charging device 21, a development device 22, a primary transfer roller 23, and a cleaning device 24. The photosensitive drum 20 rotates around an axis while coming into contact with the lower traveling portion of the intermediate transfer belt 14. The charging device 21, the development device 22, the primary transfer roller 23 and the cleaning device 24 are arranged around the photosensitive drum 20 in the order of the image forming process. The primary transfer roller 23 faces the photosensitive drum 20 from above across the intermediate transfer belt 14.

<Fixing Device> As shown in FIG. 2, the fixing device 12 includes a fixing belt 25, a pressing roller 26 and a heating part 27.

The fixing belt 25 as an example of a fixing member is an endless belt formed into an approximately cylindrical shape long in the front-and-rear direction. The fixing belt 25 is made by layering a metal layer and a synthetic resin layer. In the inner space of the fixing belt 25, a supporting member 25A, a pressing pad 25B and a belt guide 25C are provided. The supporting member 25A penetrates the fixing belt 25 along an axial direction of the fixing belt 25, and its end portions are supported by a fixing case 28 (see FIG. 1). The pressing pad 25B is made of heat resistant synthetic resin, and supported by the supporting member 25A so as to face the pressing roller 26 across the fixing belt 25. The belt guide 25C is made of metal, and formed in an approximately half-cylindrical shape long in the axial direction. The belt guide 25C is fixed to the supporting member 25A on an opposite side of the pressing pad 25B, and comes into contact with the inner surface of the fixing belt 25 to keep the fixing belt 25 in an approximately cylindrical shape.

The fixing belt 25 is supported by the supporting member 25A through a pair of caps (not shown) mounted to the front and rear end portions of the fixing belt 25 in a rotatable manner. The cap is formed integrally with a gear, and the fixing belt 25 is traveled by a drive force of a drive motor (not shown) connected to the gear.

The pressing roller 26 as an example of a pressing member is formed into an approximately cylindrical shape long in the front-and-rear direction, and disposed on the right side of the fixing belt 25. The pressing roller 26 is formed by layering an elastic layer 26B on the outer circumferential surface of the metal core 26A. Both axial end portions of the pressing roller 26 (the metal core 26A) are supported by a pair of movable frames (not shown) in a rotatable manner. The movable frame is supported by the fixing case 28 (see FIG. 1) in a turnable manner in the left-and-right direction, and connected to a pressure adjustment part (not shown) including a spring, an eccentric cam and the others.

When the pressure adjustment part turns the movable frame toward the fixing belt 25, the pressing roller 26 is pressed against the fixing belt 25 to form a pressure increased fixing nip N1 (a pressurized region) between the pressing roller 26 and the fixing belt 25. In a state where the pressure of the fixing nip N1 is increased, the pressing roller 26 rotates following the fixing belt 25. On the other hand, when the pressure adjustment part turns the movable frame in a direction separating the movable frame from the fixing belt 25, the pressing of the pressing roller 26 on the fixing belt 25 is released to form a pressure decreased fixing nip N1. In the state where the fixing nip N1 is formed, the fixing belt 25 is deformed by being pushed by the pressing roller 26. The fixing nip N1 (the pressurized region) refers to a region from an upstream position where the pressure is 0 Pa to a downstream position where the pressure becomes 0 Pa again via a position where the pressure is the maximum pressure.

The heating part 27 is disposed on the left side of the fixing belt 25 with a gap. The heating part 27 is an induction heating type heater for generating a magnetic field and self-heating the fixing belt 25. The belt guide 25C described above absorbs the leakage magnetic flux transmitted through the fixing belt 25 and generates heat by itself to assist the heating of the fixing belt 25. Although the induction heating type heating part 27 is disposed outside the fixing belt 25 as a heat source, a halogen heater, a carbon heater or the like may be disposed inside the fixing belt 25 instead of the induction heating type heating part.

<Conveyance Device> As shown in FIG. 1 and FIG. 2, the conveyance device 13 includes a conveyance body part 30, a registration rollers pair 31, a secondary transfer roller 32, and a plurality of conveyance rollers pairs 33 to 36.

As shown in FIG. 1, the conveyance body part 30 includes a frame for supporting the secondary transfer roller 32 and the others, and is provided between the conveyance path 6 and the inversion conveyance path 7. As shown in FIG. 2, the conveyance body part 30 includes the first to third conveyance guides 41 to 43 constituting a part of the conveyance path 6, and the first to second inversion conveyance guides 44 to 45 constituting a part of the inversion conveyance path 7. The first to third conveyance guides 41 to 43 and the first to second inversion conveyance guides 44 to 45 are members for guiding the conveyance of the sheet S. The sheet S is conveyed along (or in contact with) the first to third conveyance guides 41 to 43 and the first to second inversion conveyance guides 44 to 45.

As shown in FIG. 1, the right side surface of the apparatus main body 2 serves as forming a cover 46 which faces the first to second inversion conveyance guides 44 to 45 and constitutes the inversion conveyance path 7. The cover 46 is provided on the apparatus main body 2 in an openable and closable manner, constitutes the right side surface of the apparatus main body 2 in a closed state, and is opened to remove the sheet S jammed in the conveyance path 6 and the inversion conveyance path 7.

As shown in FIG. 1 and FIG. 2, the registration rollers pair 31 and the secondary transfer roller 32 are disposed in the upstream portion of the conveyance path 6, and the plurality of conveyance rollers pairs 33 to 36 are disposed on the downstream portion of the conveyance path 6 and on the inversion conveyance path 7. The registration rollers pair 31 and the conveyance rollers pairs 33 to 36 convey the sheet S held between the rollers by rotating around an axis in contact with the sheet S. The secondary transfer roller 32 conveys the sheet S by rotating around an axis in a state where the sheet S is held between the secondary transfer roller 32 and the intermediate transfer belt 14.

The registration rollers pair 31 is provided on the downstream side (the upper side) of the merging part with the inversion conveyance path 7 and on the upstream side (the lower side) of the secondary transfer roller 32. One roller of the registration rollers pair 31 is supported by the conveyance body part 30, and the other roller is supported by the apparatus main body 2. The registration rollers pair 31 temporarily blocks the sheet S conveyed on the conveyance path 6 to correct the inclination (the skew) of the sheet S.

The secondary transfer roller 32 as an example of a nip roller is supported by the conveyance body part 30 on the downstream side (the upper side) of the registration rollers pair 31 and on the upstream side (the lower side) of the fixing device 12. The secondary transfer roller 32 is in contact with the right end of the intermediate transfer belt 14 (facing the roller across the intermediate transfer belt 14) to form a transfer nip N2. The transfer nip N2 refers to a region from an upstream position where the pressure is 0 Pa to a downstream position where the pressure becomes 0 Pa again via a position where the pressure is the maximum pressure. An interval (a distance) between the transfer nip N2 and the fixing nip N1 is set to be shorter than the size of the sheet S in the conveyance direction (for example, the short side length of the A4 paper sheet).

The conveyance rollers pair 33 is disposed on the conveyance path 6 above the fixing device 12, and the conveyance rollers pair 34 is disposed on the upstream portion of the inversion conveyance path 7. The conveyance rollers pairs 35 to 36 are disposed on the midstream portion and the downstream portion of the inversion conveyance path 7. One rollers of the conveyance rollers pair 35 to 36 are supported by the conveyance body part 30, and the other rollers are supported by the cover 46.

As shown in FIG. 2, the upstream first conveyance guide 41 is disposed between the registration rollers pair 31 and the secondary transfer roller 32. The first conveyance guide 41 guides the sheet S after passing through the registration rollers pair 31. The midstream second conveyance guide 42 is disposed between the secondary transfer roller 32 and the fixing device 12. The second conveyance guide 42 guides the sheet S after passing the secondary transfer roller 32 (the transfer nip N2). The downstream third conveyance guide 43 is disposed on the downstream side of the fixing device 12. The third conveyance guide 43 guides the sheet S after passing the fixing nip N1. The first to second inversion conveyance guides 44 to 45 are disposed between the plurality of conveyance rollers pairs 33 to 36 disposed on the inversion conveyance path 7, and guides the sheet S passed through the inversion conveyance path 7.

[Image Forming Process] The operation of the image forming apparatus 1 will be described. The controller (not shown) performs the image forming process as follows based on the image data input from the external terminal.

The charging device 21 charges the surface of the photosensitive drum 20. The optical scanner 16 exposes the photosensitive drum 20 to form an electrostatic latent image corresponding to the image data on the surface of the photosensitive drum 20. The development device 22 develops the electrostatic latent image on the photosensitive drum 20 into a toner image by using the toner supplied from the toner container 5. The toner images of the four colors carried on the four photosensitive drums 20 are sequentially transferred to the traveling intermediate transfer belt 14 by the primary transfer rollers 23 to which a primary transfer bias is applied. The intermediate transfer belt 14 carries a full-color toner image formed by superposing the toner images of the four colors while traveling. The cleaning device 24 removes the toner remaining on the surface of the photosensitive drum 20 after the primary transfer.

The sheet feeding device 10 takes out the sheet S stored in the cassette 3 and feeds it to the conveyance path 6. The registration rollers pair 31 sends the skew corrected sheet S downstream. The secondary transfer roller 32 applied with a secondary transfer bias secondarily transfers the toner image on the intermediate transfer belt 14 to the surface of the sheet S passing through the transfer nip N2. The fixing device 12 thermally fixes the toner image on the paper S by passing the sheet S between the fixing belt 25 rotating around the axis and the pressing roller 26 (the fixing nip N1). In the case of one-side printing, the sheet S on which the toner image is fixed (on which the image is formed) is discharged to the sheet discharge tray 4.

When the both-side printing is performed, the sheet S passed through the fixing device 12 is switched back at the downstream end portion of the conveyance path 6 and sent to the inversion conveyance path 7. The plurality of conveyance rollers pairs 34 to 36 convey the sheet S along the inversion conveyance path 7, and the sheet S enters the conveyance path 6 again from the inversion conveyance path 7. Then, an image is formed on the back surface of the sheet S by the same procedure as in the one-side printing described above.

Although the heating part 27 of the fixing device 12 heats the fixing belt 25, the pressing roller 26 pressed against the fixing belt 25 is also indirectly heated through the fixing belt 25. The fixing belt 25 and the pressing roller 26 thermally expand to enlarge their outer diameters. As shown in FIG. 3, the sheet S passes through a medium passing region P set in an intermediate area except both the axial end areas of the fixing belt 25 and the pressing roller 26, and does not pass through a pair of medium non-passing regions NP set on both the axial end areas of the pressing roller 26 or the others (FIG. 3 shows only the pressing roller 26). Since the sheet S (and the toner) takes (absorbs) the heat of the pressing roller 26 and the others, the temperature of the medium passing region P of the pressing roller 26 and the others becomes slightly lower than the temperature of the medium non-passing region NP. The medium non-passing region NP of the pressing roller 26 and the others is higher in temperature than the medium passing region P, and therefore has a larger diameter than the medium passing region P. Compared with the fixing belt 25 deformed by being pushed by the pressing roller 26, the pressing roller 26 is more likely to have an inverted crown shape (refer to the two-dot chain line shown in FIG. 3) in which the medium non-passing region NP is enlarged in diameter than the medium passing region P. The sheet S passing through the fixing nip N1 is curved along the inverted crown shape of the pressing roller 26. The curved sheet S is hardly curved in the conveyance direction (its rigidity is improved).

As described above, the secondary transfer roller 32 conveys the sheet S on the upstream side of the fixing device 12 while holding it between the secondary transfer roller 32 and the intermediate transfer belt 14 (the transfer nip N2), and the sheet S may be temporarily held between the fixing nip N1 and the transfer nip N2. In a case where the pressing roller 26 has the inverted crown shape, the leading side portion of the sheet S held in the fixing nip N1 is curved, and the trailing side portion of the sheet S held in the transfer nip N2 is not curved. When the conveyance of the sheet S proceeds from this state, as soon as the trailing end of the sheet S comes out of the transfer nip N2, the trailing end portion of the sheet S is moved so as to be bounced leftward in FIG. 2 (so-called “sheet bounce” is generated). When the sheet bounce is generated, because the conveyance of the sheet S becomes unstable and the posture of the sheet S changes slightly, a deviation (a disturbance) of the fixing image may occur. Therefore, the image forming apparatus 1 according to the present embodiment is provided with an intake/exhaust structure 50 which cools the fixing device 12, specifically, the pair of medium non-passing regions NP of the pressing roller 26 while stabilizing the conveyance of the sheet S.

[Intake/Exhaust Structure] With reference to FIG. 2 and FIG. 3, the intake/exhaust structure 50 will be described. The intake/exhaust structure 50 includes an air blower 51, an intake duct 54, and a pair of exhaust ducts 55.

<Air Blower> The air blower 51 is disposed on the rear side of the rear surface of the second conveyance guide 42 (the surface opposite to the conveyance surface for the sheet S), and is fixed to the conveyance body part 30. The air blower 51 is a sirocco fan having an impeller 53 rotatably supported by a casing 52, for example.

(Casing) The casing 52 includes an intake part 52A serving as an air intake port and an exhaust part 52B serving as an air discharge port. The intake part 52A is formed on the left surface of the casing 52 (the surface facing the second conveyance guide 42) so as to correspond to the center of the impeller 53. The exhaust part 52B is formed so as to project obliquely from the rear to the front at the upper portion of the casing 52.

(Impeller) The impeller 53 is formed in a substantially cylindrical shape formed by disposing a plurality of blades (not shown), and rotates around an axis by being applied with a driving force of a motor (not shown). When the impeller 53 rotates, air is taken into the center of the impeller 53 from the intake part 52A, becomes a rotational flow outwardly in the radial direction of the impeller 53, flows along the inner surface of the casing 52, and is discharged through the exhaust part 52B.

<Intake Duct> The intake duct 54 is fixed to the rear surface of the second conveyance guide 42. Two intake ports 42A are opened in the central area (the area through which the sheet S passes) of the second conveyance guide 42 in the front-and-rear direction, and the intake duct 54 is formed so as to communicate the two intake ports 42A with the intake part 52A of the air blower 51. The intake duct 54 is a flow passage (a tube) for guiding the air taken in through the intake ports 42A to the intake part 52A. Specifically, the intake duct 54 extends downward from the portion fixed to the rear surface of the second conveyance guide 42 so as to cover the two intake ports 42A, and then bends to extend rearward, and the end thereof is connected to the intake part 52A of the air blower 51.

<Exhaust Duct> The pair of exhaust ducts 55 is disposed on the rear side of the second conveyance guide 42, and fixed to the conveyance body part 30 (or the second conveyance guide 42). The pair of exhaust ducts 55 is formed so as to communicate the exhaust part 52B of the air blower 51 with areas facing the pair of medium non-passing regions NP of the pressing roller 26. The pair of exhaust ducts 55 are flow passages (pipes) for guiding the air discharged from the exhaust part 52B to the pair of medium non-passing regions NP of the pressing roller 26.

More specifically, as shown in FIG. 3, the pair of exhaust ducts 55 are connected at the most upstream portion in the air flow direction, and are integrally formed. The most upstream portion (the connecting portion) of the pair of exhaust ducts 55 is connected to the exhaust part 52B of the air blower 51. The front exhaust duct 55 toward the forward medium non-passing region NP extends forward in a substantially horizontal direction from the exhaust part 52B, and then bends to extend upward, with its end facing the forward medium non-passing region NP. The rear exhaust duct 55 toward the rear medium non-passing region NP extends obliquely upward and rearward from the exhaust part 52B, with its end facing the rear medium non-passing region NP. The front exhaust duct 55 is formed longer than the rear exhaust duct 55.

Although the exhaust ducts 55 have different length each other, they are configured to have a uniform quantity of air blown to the medium non-passing regions NP of the pressing roller 26. Specifically, in the upstream portions of the exhaust ducts 55 (near the connecting portion), the front exhaust duct 55 have a diameter larger than a diameter of the rear exhaust duct 55. That is, a width (W1) of the air flow passage of the front exhaust duct 55 is set to be larger than a width (W2) of the air flow passage of the rear exhaust duct 55. That is, the front exhaust duct 55 has a cross-sectional area larger than a cross-sectional area of the rear exhaust duct 55. Further, because the exhaust part 52B of the air blower 51 is inclined toward the front exhaust duct 55, the exhaust air is easily blown to the front exhaust duct 55. According to the above-described configuration, a quantity of the air blown to the medium non-passing regions NP is adjusted so as to be equal. The exhaust ducts 55 have substantially the same size (the width and the cross-sectional area of the air flow passage) except for the upstream portion of the pair of exhaust ducts 55 (near the connecting portion). Further, “a quantity of the air blown to the medium non-passing regions NP is equal” does not mean that the quantity of the air is required to be exactly equal, but means that a slight error is allowed.

[Operation of Intake/Exhaust Structure] Next, the operation of the intake/exhaust structure 50 will be described with reference to FIG. 2 and FIG. 3.

When the image forming process described above is started, the controller drives the air blower 51 (the motor) to rotate the impeller 53. A suction force is generated in the intake part 52A by rotation of the impeller 53, and air above the second conveyance guide 42 is sucked into the intake part 52A from each intake port 42A through the intake duct 54. When the leading portion of the sheet S passed through the transfer nip N2 comes to the second conveyance guide 42, it is attracted to the second conveyance guide 42 by the suction force acting around each intake port 42A. That is, the sheet S is conveyed while being lightly attracted on the second conveyance guide 42.

When the leading portion of the sheet S enters the fixing nip N1, the sheet S is held between the fixing nip N1 and the transfer nip N2. Even if the sheet S is further conveyed from this state and the trailing end of the sheet S comes off from the transfer nip N2, the trailing portion of the sheet S is lightly attracted on the second conveyance guide 42, so that the sheet bounce is prevented. Note that “attracting the sheet S on the second conveyance guide 42” may be a state in which the sheet S is tightly attracted on the second conveyance guide 42, or a state in which the sheet S is slightly away from the second conveyance guide 42 but is attracted to the side of the second conveyance guide 42. In other words, it is sufficient that the sheet S is attracted to the side of the second conveyance guide 42 so as to prevent the sheet bounce.

On the other hand, the air blower 51 discharges the air sucked through the intake part 52A, from the exhaust part 52B. The air discharged from the exhaust part 52B is distributed to approximately the same quantity, flows through the exhaust ducts 55, and is blown to the medium non-passing regions NP of the pressing roller 26. The medium non-passing regions NP are cooled by the blown air, and the pressing roller 26 is prevented from being deformed in the inversed crown shape.

In the image forming apparatus 1 according to the present embodiment described above, the air blower 51 sucks the air above the second conveyance guide 42 to attract the sheet S toward the second conveyance guide 42. According to this configuration, the sheet S is conveyed while being attracted to the second conveyance guide 42, so that the stable sheet passing can be performed without disturbing the posture of the sheet S on the second conveyance guide 42. Further, the air blower 51 blows the sucked air toward the medium non-passing regions NP of the pressing roller 26. According to this configuration, the medium non-passing regions NP of the pressing roller 26 are cooled by the blown air, and the expansion of the diameter of the medium non-passing regions NP can be suppressed. As described above, the fixing device 12 (the pressing roller 26) can be cooled while conveying the sheet S stably. Further, the intake air and the exhaust air of one air blower 51 can be used in common for the stable sheet conveyance and the cooling of the pressing roller 26, so that the installation space can be reduced and the manufacturing cost can be reduced as compared with the case where a means for attracting the sheet S and a means for cooling the pressing roller 26 are separately provided.

According to the image forming apparatus 1 of the present embodiment, the second conveyance guide 42 is provided between the secondary transfer roller 32 and the fixing device 12, and the trailing portion of the sheet S passed through the transfer nip N2 can be conveyed while attracted to the second conveyance guide 42. Therefore, it becomes possible to prevent the sheet bounce after the trailing portion of the sheet S is passed through the transfer nip N2.

According to the image forming apparatus 1 of the present embodiment, the air above the second conveyance guide 42 can be efficiently sucked through the intake duct 54. Therefore, it becomes possible to convey the sheet S along the second conveyance guide 42 surely.

According to the image forming apparatus 1 of the present embodiment, the quantity of the air passing through the exhaust ducts 55 is equal, so that both the axial end portions (the medium non-passing regions NP) of the pressing roller 26 can be cooled uniformly.

In the image forming apparatus 1 according to the present embodiment, the air blower 51 is a so-called sirocco fan, but the air blower 51 may be a propeller fan for flowing air along a rotary shaft (not shown), for example. Further, although the air blower 51 is disposed on the rear side of the rear surface of the second conveyance guide 42, it may be disposed on the front side of the rear surface or in the middle of the front-and-rear direction (not shown). Further, although the air blower 51 is fixed to the conveyance body part 30 (or the second conveyance guide 42), it may be provided at any position in the apparatus main body 2 different from the conveyance device 13 (not shown). In these cases, it is preferable to appropriately change the shapes and mounting positions of the intake duct 54 and the exhaust ducts 55.

In the image forming apparatus 1 according to the present embodiment, the air above the second conveyance guide 42 is sucked through the intake duct 54, but the present disclosure is not limited thereto. For example, instead of the intake duct 54, the intake ports 42A of the second conveyance guide 42 and the intake part 52A of the air blower 51 may be connected by tubes (not shown). For example, the intake duct 54 may be omitted, and the intake part 52A of the air blower 51 may be disposed close to (or in contact with) the respective intake ports 42A of the second conveyance guide 42 to directly suck the air above the second conveyance guide 42 (not shown). Further, at least one intake port 42A may be formed.

Further, in the image forming apparatus 1 according to the present embodiment, the air discharged from the air blower 51 is blown to the medium non-passing regions NP via the exhaust ducts 55, but the present disclosure is not limited thereto. For example, instead of the exhaust ducts 55, the exhaust part 52B of the air blower 51 and the areas facing the medium non-passing regions NP may be communicated by a tube (not shown). For example, the exhaust ducts 55 may be omitted, the exhaust part 52B of the air blower 51 may be branched in two, and the branched exhaust part 52B may face the medium non-passing regions NP (not shown).

In the image forming apparatus 1 according to the present embodiment, the air blower 51 (the exhaust ducts 55) blows air to both the axial end portions (the medium non-passing regions NP) of the pressing roller 26, but the present disclosure is not limited thereto. For example, the air blower 51 (the exhaust ducts 55) may be configured to blow air over the entire axial area of the pressing roller 26 (not shown). For example, the air blower 51 (the exhaust ducts 55) may blow air to both axial end portions (the medium non-passing regions NP) of the fixing belt 25 not the pressing roller 26, or may blow air to the medium non-passing regions NP of both the fixing belt 25 and the pressing roller 26 (not shown).

The image forming apparatus 1 (the intake/exhaust structure 50) according to the present embodiment is configured to convey the sheet S before fixing while attracting it to the second conveyance guide 42 from the viewpoint of preventing the sheet bounce, but the present disclosure is not limited thereto. For example, as another image forming apparatus (the intake/exhaust structure), an intake port may be formed in the third conveyance guide 43, the intake port 42A and the intake part 52A of the air blower 51 may be communicated with each other by the intake duct 54, and the sheet S after fixing S may be conveyed while attracted to the third conveyance guide 43 (not shown). Alternatively, the sheet S may be conveyed while attracted toward the first conveyance guide 41, or the first inversion conveyance guide 44, or the second inversion conveyance guide 45 (not shown).

Although the image forming apparatus 1 according to the present embodiment is a color printer, the present disclosure may be applied to a monochrome printer, a copying machine, a facsimile machine, a multifunction machine, or the like, for example.

It should be noted that the description of the above embodiment shows an aspect of the image forming apparatus according to the present disclosure, and the technical scope of the present disclosure is not limited to the above embodiment. The present disclosure may be variously changed, substituted or modified without departing from the spirit of the technical idea, and the claims include all embodiments that may be included within the scope of the technical idea.

1. An image forming apparatus comprising:
a conveyance device which conveys a medium along a conveyance guide;
a fixing device which fixes a toner image on the medium thermally by passing the medium between a fixing member and a pressing member which are rotated around axes; and
an air blower which sucks air above the conveyance guide to attract the medium to the conveyance guide, and blows the sucked air to a pair of medium non-passing regions set on both end portions of at least the fixing member and the pressing member in the axial direction.

2. The image forming apparatus according to claim 1, wherein
a nip at which the medium is held and conveyed is formed on an upstream side of the fixing device in a conveyance direction, and
the conveyance guide is provided between the nip and the fixing device.

3. The image forming apparatus according to claim 1, further comprising:
an intake duct communicating an intake port opened to the conveyance guide with an intake part of the air blower.

4. The image forming apparatus according to claim 3, wherein
the intake port is opened to a center area of the conveyance guide in the axial direction.

5. The image forming apparatus according to claim 1, further comprising:
a pair of exhaust ducts communicating an exhaust part of the air blower with areas facing the pair of medium non-passing regions and configured such that a quantity of air blown to the medium non-passing regions is equal.

6. The image forming apparatus according to claim 1, wherein
the air blower blows the sucked air to the medium non-passing regions of the pressing roller.
